(19) United States
(12) Patent Application Publication
(10) Pub. No.: US 2015/0157932 A1
(43) Pub. Date: Jun. 11, 2015

(54) METHOD OF PROCESSING USER GESTURE INPUTS IN ONLINE GAME

(71) Applicant: WEMADE ENTERTAINMENT CO., LTD., Seoul (KR)

(72) Inventors: Won Suk Kwon, Gyeonggi-do (KR); Jae Yoon Kim, Gyeonggi-do (KR); Jae Hyun Park, Seoul (KR)

(73) Assignee: WEMADE ENTERTAINMENT CO., LTD a corporation

(21) Appl. No.: 14/412,805

(22) PCT Filed: Nov. 9, 2012
(86) PCT No.: PCT/KR2012/009450

§ 371 Date: Jan. 5, 2015

(30) Foreign Application Priority Data
Jul. 6, 2012 (KR) 10-2012-0074111

(51) Int. Cl. A63F 13/2145; A63F 13/428; G06F 3/01

(52) U.S. Cl. CPC A63F 13/2145; G06F 3/017; A63F 13/428

(57) ABSTRACT

A method of processing user gestures in an online game. A method of processing user gestures in an online game performed via a mobile terminal capable of receiving a touch-drag input according to an embodiment of the present invention may minimize the number of touches required for performing efficient and rapid operations, improve operating convenience, and provide pleasant view.

### CROSS-REFERENCE TO RELATED APPLICATIONS

This application is the National Stage of International Application No. PCT/KR2012/009450 having International filing date 9 Nov. 2012, which designated the United States of America, and which claims priority from, and the benefit of, Korean Application No. 10-2012-0074111, filed on 6 Jul. 2012, the disclosures of which are incorporated herein by reference in their entireties.

### FIELD

The presently disclosed embodiment relates to a method of processing user gesture inputs in an online game.

### BACKGROUND

Recently, mobile game market has been significantly grown along with rapid propagation of mobile terminals, such as smart phones and tablet PCs. In the early period, quality of games was poor due to limits in performance of terminals. However, although current terminals provide sufficient CPU and graphic performance, it is difficult to play an online game by using a mobile terminal due to lack of sufficient user interfaces, such as a keyboard and a mouse.

As mobile terminals employing full touch screens have been introduced, a mobile terminal displays a virtual keypad screen image, virtual arrow keys, and virtual operation keys on a touch screen, without a separate keypad. However, such virtual user interfaces occupy portions of a display screen image of a small-sized mobile terminal, thereby interrupting view of a user and play screen image of an online game.

Meanwhile, although a gesture system has been applied to various applications and functions along with propagation and development of smart phones or tablet PCs, the gesture system is limitedly applied to an online system due to technical limits. For example, in an online game including a massive multiplayer online role playing game (referred to hereinafter as ‘MMORPG’), it is necessary to continuously check status of a character or a monster and detect input gestures, and thus it is difficult to apply a gesture system thereto. Furthermore, since 3D movements of a character are embodied with touch-drag inputs, it is difficult to distinguish touch-drag inputs for moving a character and touch-drag inputs for applying skills of the character.

### SUMMARY

The presently disclosed embodiment provides a method of processing user gestures in an online game for minimizing the number of touches required for performing efficient and rapid operations, improving operating convenience, and providing pleasant view, in case of playing the online game by using a mobile terminal.

The presently disclosed embodiment also provides computer readable recording medium having recorded thereon a computer program for implementing a method of processing user gestures in an online game for minimizing the number of touches required for performing efficient and rapid operations, improving operating convenience, and providing pleasant view, in case of playing the online game by using a mobile terminal.

The presently disclosed embodiment also provides a mobile terminal for processing user gesture inputs in an online game, the mobile terminal capable of minimizing the number of touches required for performing efficient and rapid operations, improving operating convenience, and providing pleasant view, in case of playing the online game by using a mobile terminal.

According to an aspect of the presently disclosed embodiment, there is provided a method of processing user gestures in an online game performed via a mobile terminal capable of receiving a touch-drag input, the method including determining whether a target character of the online game is targeted; and performing a function corresponding to a gesture including at least one dragging direction in case where the target character is targeted or moving a user's character based on the touch-drag input in case where the target is not targeted.

The method further includes, if the target character is targeted, determining valid range of the gesture input; and, if the gesture input is within the valid range, performing a function corresponding to the input gesture, wherein the valid range is within the playing area of the user's character and the target character in the display area of the mobile terminal.

If the starting point of a drag constituting the gesture is located within the valid range, the gesture is determined as a gesture within the valid range.

If the starting point of a drag constituting the gesture is located within the valid range, the gesture is determined as a gesture within the valid range regardless of location of the end point of the gesture.

The method further includes displaying a trail of the gesture from a location in the display area of the mobile terminal, the location corresponding to the starting point of a drag constituting the gesture.

If a function corresponding to the gesture is performed, an icon corresponding to the performed function and a shape indicating the gesture are displayed in the display area of the mobile terminal.

The gesture includes a unidirectional drag, and the gesture is determined as a gesture input within a valid range if the gesture is located within at least one from between valid ranges respectively set with respect to the X-axis and the Y-axis.

The gesture includes drags in multiple directions, if each of drags in first through N^{th} directions (N is an integer equal to or greater than 2) is within at least one from between valid ranges respectively set with respect to the X-axis and the Y-axis, and, if N−1 drags are valid, the gesture is determined as a gesture input within a valid range.

It is determined whether the gesture consisting of drags in multiple directions including the drags in the first through N^{th} directions is a gesture input within a valid range, regardless of beginning order of directions of input drags.

If the input gesture is not a gesture within the valid range, a function corresponding to a gesture similar to the input gesture is performed.

The function includes at least one skill to be used by the user's character.

A gesture guide, which includes at least one function to be used by the user's character and gestures including the at least one dragging direction mapped to the function, is displayed in the display area of the mobile terminal.

The online game is a RPG game including a MMORPG/MORPG, an aeon of strife (AOS) game, a real time strategy (RTS) game, a first/third person shooters (FPS/TPS) game, or a sport game.

According to another aspect of the presently disclosed embodiment, there is provided a method of processing user gestures in an online game performed via a mobile terminal capable of receiving a touch-drag input, the method including determining whether a target character of the online game is targeted; if the target character is targeted, determining a gesture input based on at least one from between dragging directions and the number of drags; and, if it is determined that a valid gesture is input, performing a function corresponding to the input gesture.

The method further includes, if the target character is not targeted, moving a user's character based on the touch-drag input.

According to another aspect of the presently disclosed embodiment, there is provided a mobile terminal for processing user gesture inputs in an online game, wherein the mobile terminal is capable of receiving touch-drag inputs and includes a targeting determining unit, which determines whether a target character is targeted in the online game; and a control unit, which performs a function corresponding to a gesture including at least one dragging direction, if the target character is targeted, determining valid range of the gesture input; and performing a function corresponding to the input gesture in case where the gesture input is within the valid range or moving a user's character based on the touch-drag input in case where the target character is not targeted.

According to another aspect of the presently disclosed embodiment, there is provided a computer readable recording medium having recorded thereon a computer program for implementing a method of processing user gestures in an online game performed via a mobile terminal capable of receiving a touch-drag input, the computer readable recording medium including a first program code for determining whether a target character of the online game is targeted; a second program code for performing a function corresponding to a gesture including at least one dragging direction in case where the target character is targeted; and a third program code for moving a user's character based on the touch-drag input in case where the target is not targeted.

A method of processing user gestures in an online game performed via a mobile terminal capable of receiving a touch-drag input according to an aspect of the presently disclosed embodiment may minimize the number of touches required for performing efficient and rapid operations, improve operating convenience, and provide pleasant view.

### BRIEF DESCRIPTION OF THE DRAWINGS

FIG. 1 is a schematic diagram for describing mobile terminals for processing user gesture inputs on an online game system, according to an aspect of the presently disclosed embodiment;

FIG. 2 is a flowchart for describing a method of processing user gesture inputs in an online game according to another aspect of the presently disclosed embodiment;

FIG. 3 is a flowchart for describing a method of processing user gesture inputs in an online game, according to another aspect of the presently disclosed embodiment;

FIG. 4 is a diagram for describing inputting and displaying user gesture inputs according to an aspect of the presently disclosed embodiment;

FIG. 5 is another diagram for describing inputting and displaying user gesture inputs according to an aspect of the presently disclosed embodiment;

FIG. 6 is another diagram for describing inputting and displaying user gesture inputs according to an aspect of the presently disclosed embodiment;

FIG. 7 is another diagram for describing inputting and displaying user gesture inputs according to an aspect of the presently disclosed embodiment;

FIG. 8 is a diagram for describing determination of user gesture according to an aspect of the presently disclosed embodiment;

FIGS. 9A-9C are diagrams showing an example of determining user gestures according to an aspect of the presently disclosed embodiment, which is a diagram for describing a gesture including a unidirectional drag;

FIGS. 10A-10B are diagrams showing another example of determining user gestures according to an aspect of the presently disclosed embodiment, which is a diagram for describing a gesture including drags in multiple directions; and

FIGS. 11A through 17B are diagrams for describing user gestures of various forms and functions thereof, according to an aspect of the presently disclosed embodiment.

### DETAILED DESCRIPTION

Reference will now be made in detail to aspects of the presently disclosed embodiment, examples of which are illustrated in the accompanying drawings, wherein like reference numerals refer to like elements throughout. In this regard, the present aspects may have different forms and should not be construed as being limited to the descriptions set forth herein. Accordingly, the aspects are merely described below, by referring to the figures, to explain aspects of the present description. As used herein, the term “and/or” includes any and all combinations of one or more of the associated listed items.

As the disclosed embodiment allows for various changes and numerous aspects, particular aspects will be illustrated in the drawings and described in detail in the written description. However, this is not intended to limit the presently disclosed embodiment to particular modes of practice, and it is to be appreciated that all changes, equivalents, and substitutes that do not depart from the spirit and technical scope of the presently disclosed embodiment are encompassed in the presently disclosed embodiment. In the description of the presently disclosed embodiment, certain detailed explanations of related art are omitted when it is deemed that they may unnecessarily obscure the essence of the disclosed embodiment.

In aspects of the presently disclosed embodiment, the terms “communication”, “communication network”, and “network” may be synonyms. These terms refer to a narrow area communication network or a wide area comment network capable of transmitting and receiving files between a user terminal and a server via wires or wirelessly.

Hereinafter, the term “server” refers to a server computer that users access to use game content. In small games or games with a small number of users, a plurality of game programs may be operated at a single game server. On the other hand, in a very large game or a game with a large number of users simultaneously accessing the game, there may be more than one server for operating a single game. Furthermore, middleware regarding databases or servers for processing payments may be connected to a game server. However, descriptions thereof will be omitted below.

Hereinafter, the term “computer game” refers to game content that users may use by accessing the game server. Particularly, the term “computer game” refers to a computer game, in which a plurality of users may simultaneously play and upgrade levels of characters by training characters or obtaining experience points. Furthermore, the term “computer game” refers to a computer game, in which users may purchase various types of items for smooth gameplay.

Furthermore, various group communities may be used in a computer game. For example, guilds or clans in a computer game may be formed. The terms “guild” or “clan” refers to groups or organizations organized by users playing particular computer games. The reputation of each organization may be improved based on the number of users therein or levels of characters of the users therein, and various benefits in the computer game may be given based on the reputation. For example, if the reputation of a guild or a clan improves, characters thereof may be displayed differently (e.g., names of characters thereof may be changed) or benefits regarding items or facilities in the computer game may be given to characters thereof.

Furthermore, group communities available in a computer game also include a party play. The term “party” is an in-game group formed as users invite one another and accept invitations, where members of a formed party may use a dedicated chatting system or a particular marking for identifying party members in a game screen image.

Furthermore, members of a party may distribute items to one another or share a result content obtained as a result of playing the game. It may be set to equally distribute result content to each of members or to distribute at least portions of a result content to other members.

Hereinafter, the term ‘result content’ refers to all content that may be obtained by characters of users as a result of playing a game. For example, in a shooting game, experience and cyber money that can be obtained when a single game is over may be included in result content. In a sports game, experience and cyber money that can be obtained when a single game is over may be included in result content. In case of an RPG game, experience and compensation cyber money that can be obtained when a particular quest is completed or a monster is killed may be result content.

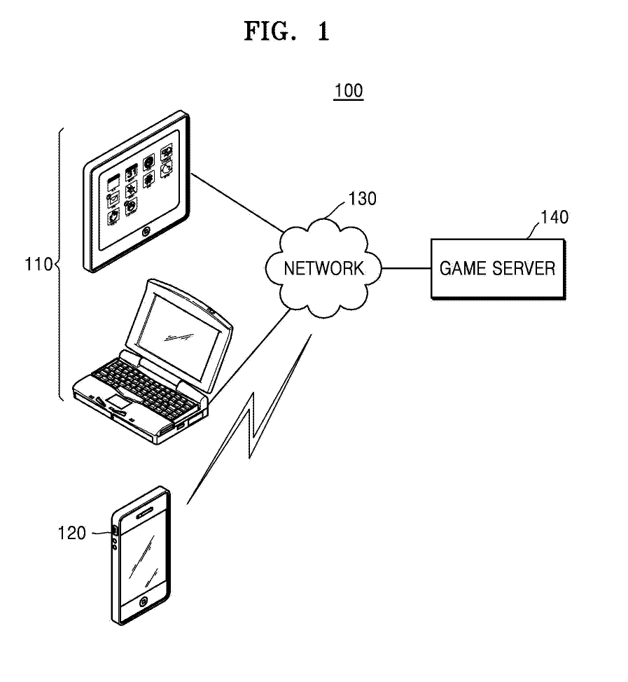

FIG. 1 is a schematic diagram for describing mobile terminals 110 and 120 for processing user gesture inputs on an online game system 100, according to an aspect of the presently disclosed embodiment.

Referring to FIG. 1, a tablet PC or laptop PC 110 and a mobile phone or smart phone 120 are shown as examples of mobile terminals, where the mobile terminal accesses a game server 140 via a network 130 and performs an online game. Here, the network 130 includes a wired network or a wireless network. The game server 140 provides an online game to a mobile terminal. Here, the online game may be a role playing game (RPG) including a MMORPG or a MORPG. A RPG may be categorized as a MMORPG or a MORPG based on the number of users accessing the RPG. Alternatively, a RPG may be categorized as a MORPG if a “room” is created and only users accessing the “room” performs battle and hunting, whereas a RPG may be categorized as a MMORPG if users perform battle and hunting in open area accessible by all users.

Furthermore, an online game may be an Aeon of Strife (AOS) game, a real time strategy (RTS) game, a first/third person shooters (FPS/TPS) game, a sport game, etc.

A program required for embodying a game may be installed and executed on a mobile terminal.

A mobile terminal embodies touch-drag function, where an online game may be played by using the touch-drag function. A mobile terminal according to an aspect of the presently disclosed embodiment processes user gesture inputs in an online game. A mobile terminal determines whether a target character in an online game is targeted and, if the target character is targeted, the mobile terminal performs a function corresponding to a gesture including at least one dragging direction. Meanwhile, if no target character is targeted, the mobile terminal controls to move a user's character based on touch-drag inputs. Here, the target character may include monsters or characters of other users in a RPG, may include enemies in a FPS/TPS game, and may include opponent characters in a sport game. Gestures include various pre-set dragging directions and may include eight directions, which includes up, down, left, right, and four tilted directions with respect to the respective four directions, circular gestures, and repetitive gestures. In case of a RPG game, a function may be a skill that may be used by a user's character, where a particular skill may be mapped to a particular gesture. Therefore, when the particular gesture is input, the particular skill may be used against a target character.

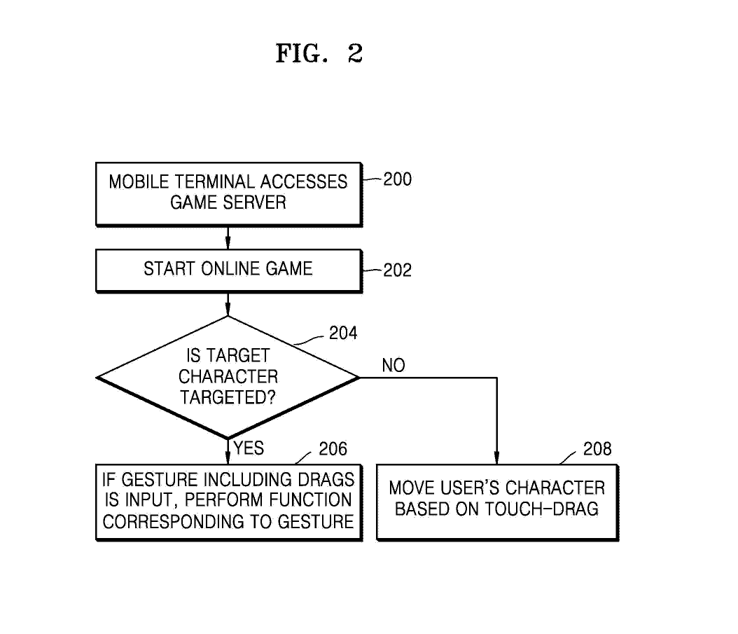

FIG. 2 is a flowchart for describing a method of processing user gesture inputs in an online game according to another aspect of the presently disclosed embodiment.

Referring to FIG. 2, in operations 200 and 202, a mobile terminal access a game server and an online game is initiated.

In an operation 204, it is determined whether a target character of the online game is targeted. Here, the target character is an opponent of a user's character, e.g., a monster, which is a target for a battle or hunting in a RPG. The target character may be targeted by touching the corresponding target character.

In an operation 204, if the target character is targeted, it is determined whether a gesture including a drag is input. If a gesture is input, a function corresponding to the gesture is performed. The function may be a weapon or an attack method that may be used by the user's character in a battle or hunting. The function may vary based on level of the user's character, where the concept may be applied not only to RPGs, but also games of other genres.

In the operation 204, if a target character is not targeted, a user's character is moved based on touch-drag inputs. For example, in a space or 3D space, a user's character may be moved to a location corresponding to a touched location or in a direction corresponding to a dragging direction.

A method of processing user gesture inputs in an online game according to an aspect of the presently disclosed embodiment enables efficient and quick performance of functions of a user's character in the online game by minimizing the number of required touch. Furthermore, since a function is performed only by inputting a gesture including touch-drags, operation convenience of a user operating a user's character may be improved. Also, since no virtual keypad or operating key is displayed on a display screen of a mobile terminal, wide view may be provided to a user.

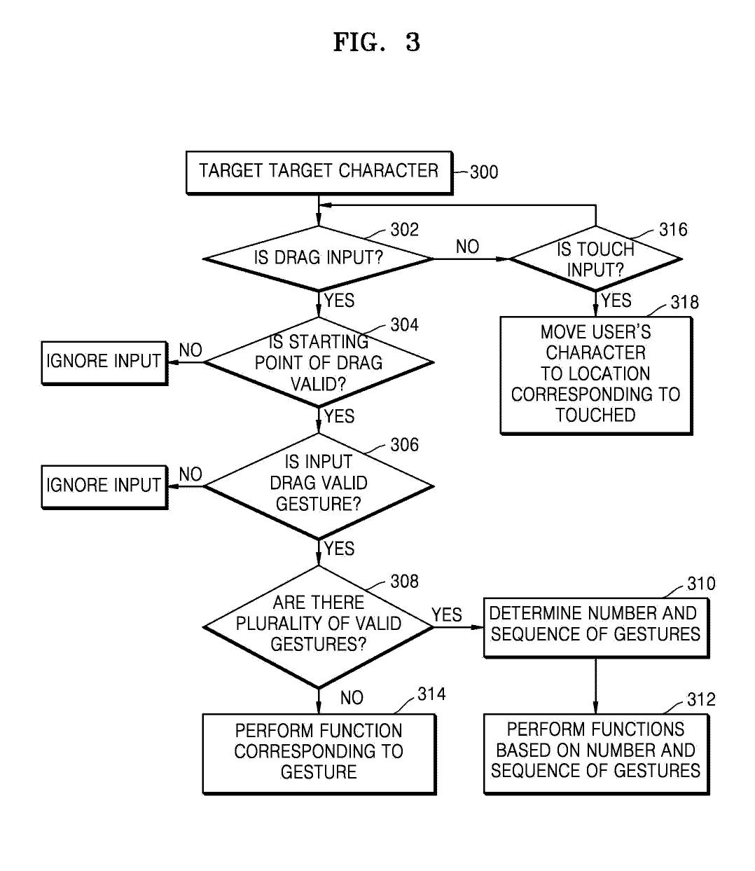

FIG. 3 is a flowchart for describing a method of processing user gesture inputs in an online game, according to another aspect of the presently disclosed embodiment.

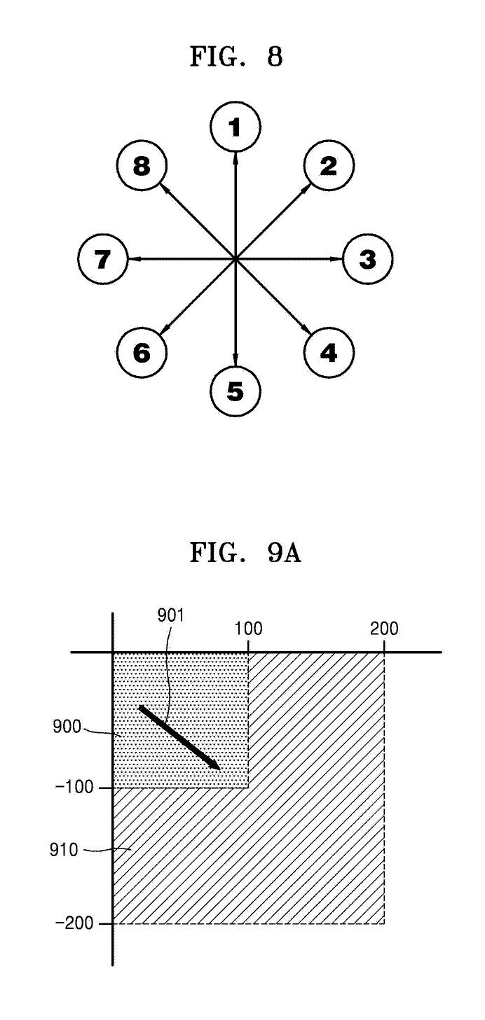

Referring to FIG. 3, in an operation 300, a target character is targeted. If there is a drag input from a user in an operation 302, it is determined in an operation 304 whether a drag starting point is valid. The drag starting point refers to a location initially touched by a user for inputting a drag, where validity of a drag starting point is determined based on whether the initially touched location corresponds to a portion of a display area of a mobile terminal, e.g., a playing area of a user's character and a target character. If a drag starting point is outside a valid area, a corresponding drag input is ignored. If the drag starting point is determined as a valid drag starting point in the operation 304, it is determined in an operation 306 whether the drag input corresponds to a valid gesture. Here, gestures include a drag in a single direction or a combination of drags in a plurality of directions. Determination of validity of gestures will be described below with reference to FIGS. 8 through 10.

If it is determined in the operation 306 that the drag input corresponds to a valid gesture, it is determined in an operation 308 whether there are a plurality of valid gestures. If there is a single valid gesture, a function corresponding to the gesture is performed in an operation 314. If there are a plurality of valid gestures, the number and sequence of the gestures are determined in an operation 310. In an operation 312, a function corresponding to the number and sequence of the gestures is performed.

If it is determined that there is no drag input, it is determined in an operation 316 whether there is a touch input. If there is a touch input, a user's character is moved to a location corresponding to coordinates of a touched location in an operation 318.

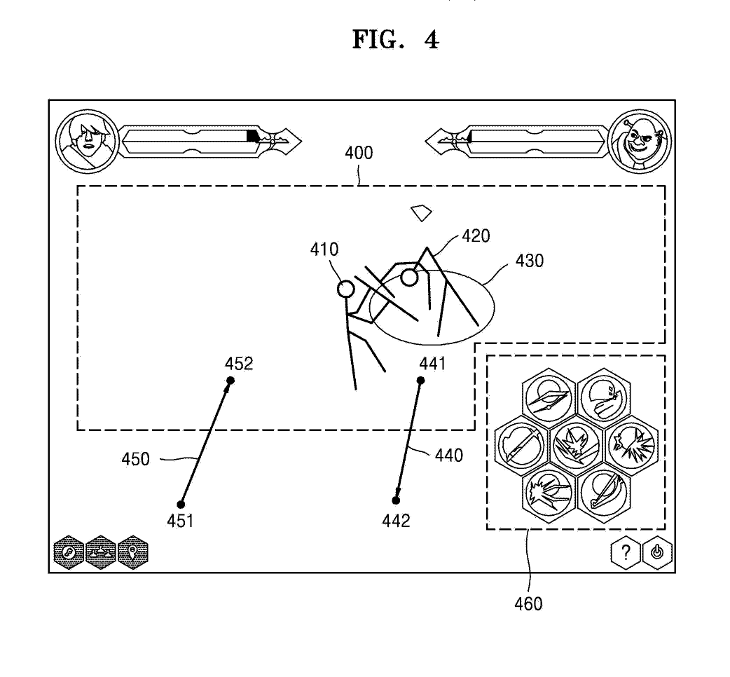

FIG. 4 is a diagram for describing inputting and displaying user gesture inputs according to an aspect of the presently disclosed embodiment.

FIG. 4 shows a valid range area 400 corresponding to a valid area for inputting gestures in a display screen of a mobile terminal. The valid range area 400 is within a playing area of a user's character 410 and a target character 420. After the target character 420 is targeted by touching the target character 420 (430), a gesture including at least one dragging direction is input. Here, although the starting point 441 of a downward gesture 440 is located within the valid range area 400, the end point of the downward gesture 440 is located outside the valid range area 400. Furthermore, the starting point 451 of an upward gesture 450 is located outside the valid range area 400, whereas the end point of the upward gesture 450 is located within the valid range area 400. According to an aspect of the presently disclosed embodiment, to guarantee validity of user gesture inputs, a gesture is determined as a valid gesture if the starting point of the gesture is located within a valid range area, where validity of the gesture is determined regardless of location of the endpoint of the gesture. In other words, in FIG. 4, the gesture 440 is determined as a valid gesture, but the gesture 450 is determined as an invalid gesture. Furthermore, a gesture input on a menu 460, where functions may be accessed via touches thereon, is also determined as an invalid gesture. In other words, a corresponding function is performed with respect to the downward gesture 440, whereas no function is performed with respect to the upward gesture 450.

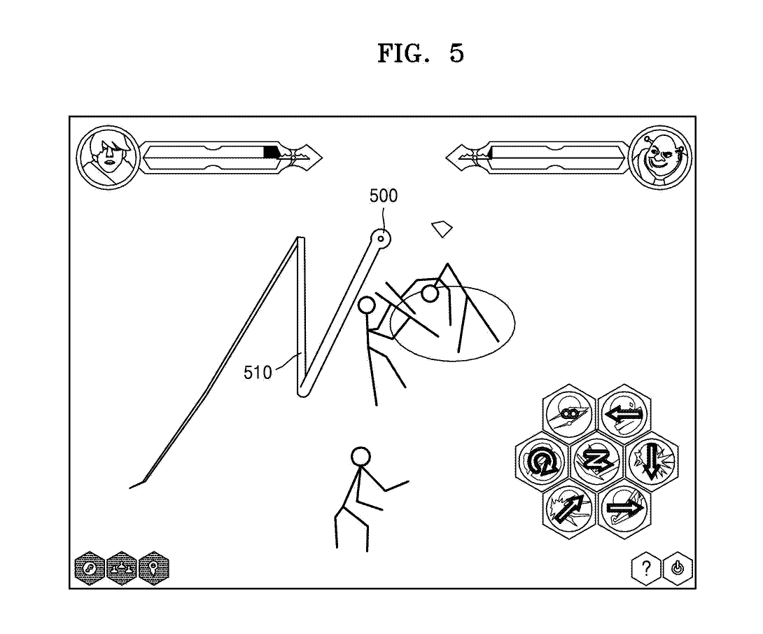

FIG. 5 is another diagram for describing inputting and displaying user gesture inputs according to an aspect of the presently disclosed embodiment.

Referring to FIG. 5, when a target character is targeted and a user inputs a drag, a trail 510 of a corresponding gesture is displayed from an initially touched point or a drag starting point 500. Furthermore, when a target character is untargeted, no trail is displayed. A trail automatically disappears as a designated period of time passes.

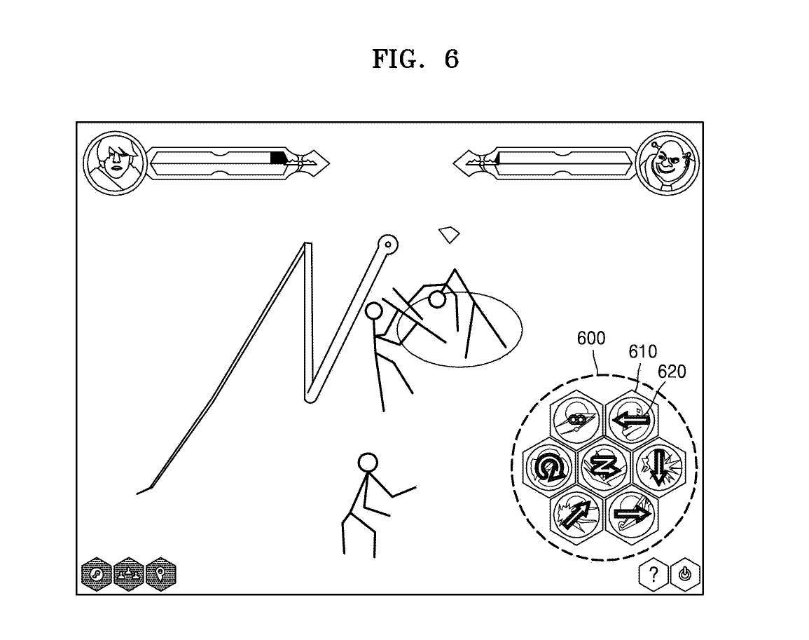

FIG. 6 is another diagram for describing inputting and displaying user gesture inputs according to an aspect of the presently disclosed embodiment.

Referring to FIG. 6, a gesture guide 600 is displayed at the lower-right corner of a screen image. The gesture guide 600 includes respective gestures 620 corresponding to functions 610 that may be used by a user's character. Furthermore, while the trail as shown in FIG. 5 is being displayed, gesture shapes of corresponding functions may be displayed on respective function icons. If a target character is untargeted, gesture shape disappears. Here, the gesture guide 600 may be displayed or disappear at a particular area of a screen image, e.g., the lower-right corner, based on a user selection.

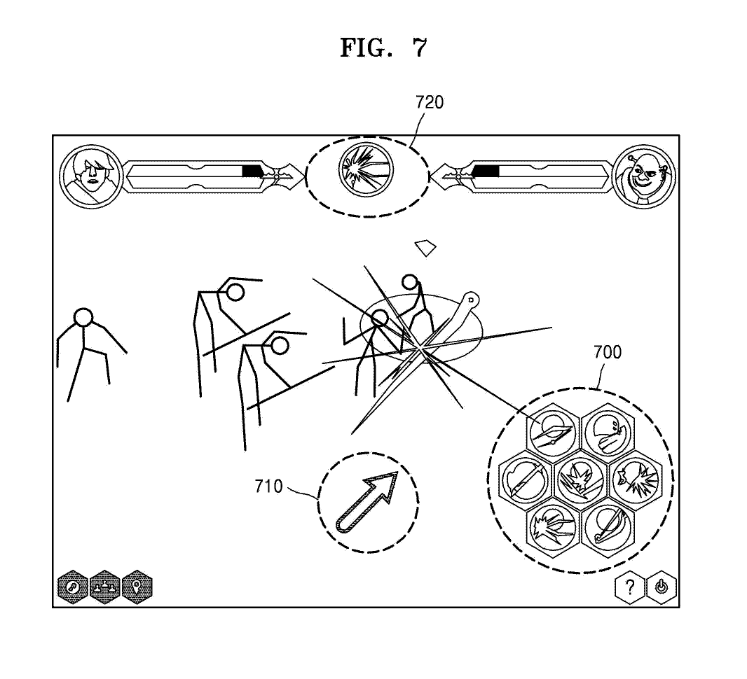

FIG. 7 is another diagram for describing inputting and displaying user gesture inputs according to an aspect of the presently disclosed embodiment.

Referring to FIG. 7, when a target character is targeted, a user inputs a valid gesture, and a function corresponding to the gesture is performed, a gesture shape 710 of the performed function is displayed at the lower-center of a screen image, and an icon 720 of the performed function is displayed at the upper-center of a screen image. Furthermore, a displayed gesture guide 700 disappears. For example, the gesture guide 700 may disappear until a next gesture is input.

FIG. 8 is a diagram for describing determination of user gesture according to an aspect of the presently disclosed embodiment.

Referring to FIG. 8, a pattern including drags in 8 directions is shown. The pattern includes four directions (up, down, left, and right) (pattern 1, pattern 3, pattern 5, and pattern 7) and four diagonal directions (pattern 2, pattern 4, pattern 6, and pattern 8). Here, although a pattern is divided into drags in 8 directions, the presently disclosed embodiment is not limited thereto, and a pattern may be divided into drags in less than or greater than 8 directions.

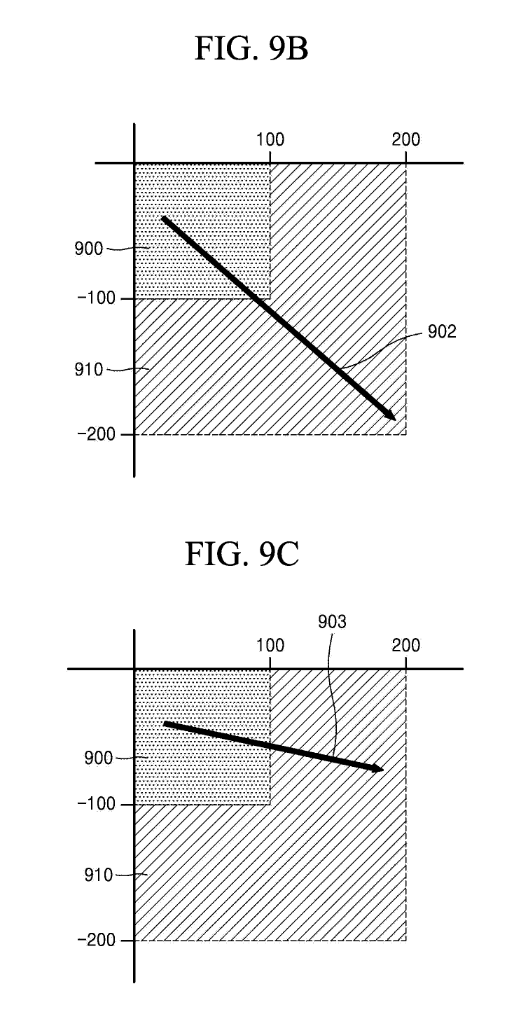

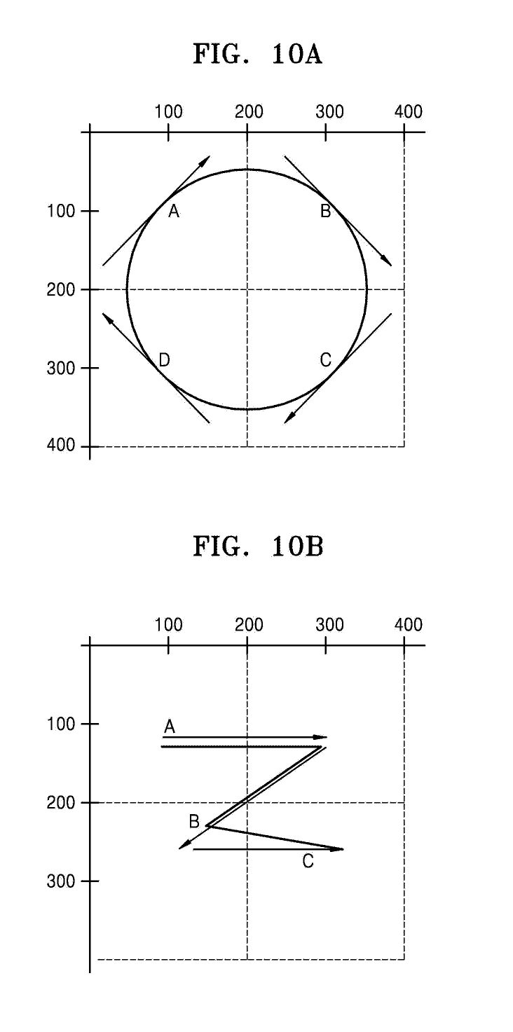

A drag pattern according to an aspect of the presently disclosed embodiment is analyzed by cumulatively calculating amounts of changes of coordinates drags moved on. Furthermore, changes in horizontal (X-axis) directions and vertical (Y-axis) directions are separately stored, stored amounts of the changes are analyzed, and, as shown in FIG. 8, the changes are determined as a single pattern. Furthermore, functions are categorized and performed based on the number of patterns and, if an accumulated amount of change exceeds a set minimum value, each of values corresponding to vertical directions and horizontal directions is stored in a single bit. For example, a value corresponding to a pattern in total 8 directions may be used. Detailed descriptions of determining a pattern will be given below with reference to FIGS. 9A and 10B.

FIGS. 9A-9C are diagrams showing an example of determining user gestures according to an aspect of the presently disclosed embodiment, which is a diagram for describing a gesture including a unidirectional drag.

Referring to FIGS. 8 and 9A, when a gesture in a dragging direction corresponding to the pattern 4 shown in FIG. 9A is input, a method of determining whether the corresponding gesture is valid will be described below. As described above with reference to FIG. 4, it is first determined whether the starting point of a drag 901 is within a valid area, and then an amount of change of coordinates a drag moved on is accumulated.

FIG. 9A shows an invalid range 900 and a valid range 910. It is determined whether accumulated amounts of changes of coordinates a drag moved on in the X-axis direction and the Y-axis direction are within the invalid range 900 or the valid range 910.

FIGS. 9A through 9C show drags 901 through 903, respectively.

Since the drag 901 as shown in FIG. 9A is within the invalid range 900 both in the X-axis direction and the Y-axis direction, the drag 901 is determined as an invalid gesture and a function corresponding to the gesture is not performed.

Since a drag 902 as shown in FIG. 9B is within the valid area 910 both in the X-axis direction and the Y-axis direction, the drag 902 is determined as a valid gesture and a function corresponding to the gesture is performed.

A drag 903 as shown in FIG. 9C is within the valid range 910 in the X-axis direction, but is within the invalid range 900 in the Y-axis direction. In this case, if a drag is within a valid range in an arbitrary axis direction, the drag is determined as a valid gesture. The drag 903 as shown in FIG. 9C is determined as a gesture corresponding to a pattern 3 as shown in FIG. 8, and a function corresponding to the gesture is performed.

FIGS. 10A-10B are diagrams showing another example of determining user gestures according to an aspect of the presently disclosed embodiment, which is a diagram for describing a gesture including drags in multiple directions.

Referring to FIGS. 10A-10B, a method of determining a gesture including drags in multiple directions (unlike a gesture including a unidirectional drag) will be described below. FIG. 10A shows a circular gesture, whereas FIG. 10B shows a repetitive gesture.

Referring to FIG. 10A, if a drag in the direction A, a drag in the direction B, a drag in the direction C, and a drag in the direction D are input as a user gesture, the drags in the directions A through D are all determined as a gesture valid in the X-axis direction and the Y-axis direction, where the drag in the direction A is determined as the pattern 2, the drag in the direction B is determined as the pattern 4, the drag in the direction C is determined as the pattern 6, and the drag in the direction D is determined as the pattern 8. Furthermore, in case of the patterns 2, 4, 6, and 8, the patterns are finally determined as a circular gesture.

Furthermore, as long as patterns are repeated in the same order of pattern 2, the pattern 4, the pattern 6, and the pattern 8, even if it is determined that drags include patterns 4, 6, 8, and 2 or patterns 6, 8, 2, 4, the drags may be determined as a valid circular gesture. In other words, as long as patterns are repeated in the same order, the patterns may be determined as a gesture regardless of the initial pattern. Furthermore, selectively, even drags including 3 patterns, e.g., patterns 2, 4, and 6 or patterns 4, 6, and 8, instead of four patterns including patterns 2, 4, 6, and 8 may also be determined as a valid circular gesture. Therefore, considering that an online game is played at a relatively fast pace, a user's intention of using a function is reflected as much as possible, instead of precision of inputs, thereby improving reliability of the online game.

Referring to FIG. 10B, when a drag in the direction A, a drag in the direction B, and a drag in the direction C are input as a user gesture, the drag in the direction A is determined as a gesture valid in the X-axis direction and invalid in the Y-axis direction and is determined as a pattern 3. The drag in the direction B is determined as a gesture valid in both the X-axis direction and the Y-axis direction and is determined as a pattern 6. The drag in the direction C is determined as a gesture valid in the X-axis direction and invalid in the Y-axis direction and is determined as a pattern 3. Therefore, the gesture shown in FIG. 10B is determined as a repetitive gesture in which patterns are repeated in the order of 3, 6, and 3.

Although methods of determining patterns are described above based on a particular pattern shape with reference to FIGS. 8 through 10B, the presently disclosed embodiment is not limited thereto, and the same methods of determining patterns may be applied to any of various other patterns.

Furthermore, selectively, if an input pattern is determined as a pattern not precisely identical to a set pattern, a function corresponding to the most similar pattern may be performed. Therefore, instead of precision of an input, a user's intention of using a function may be reflected as much as possible.

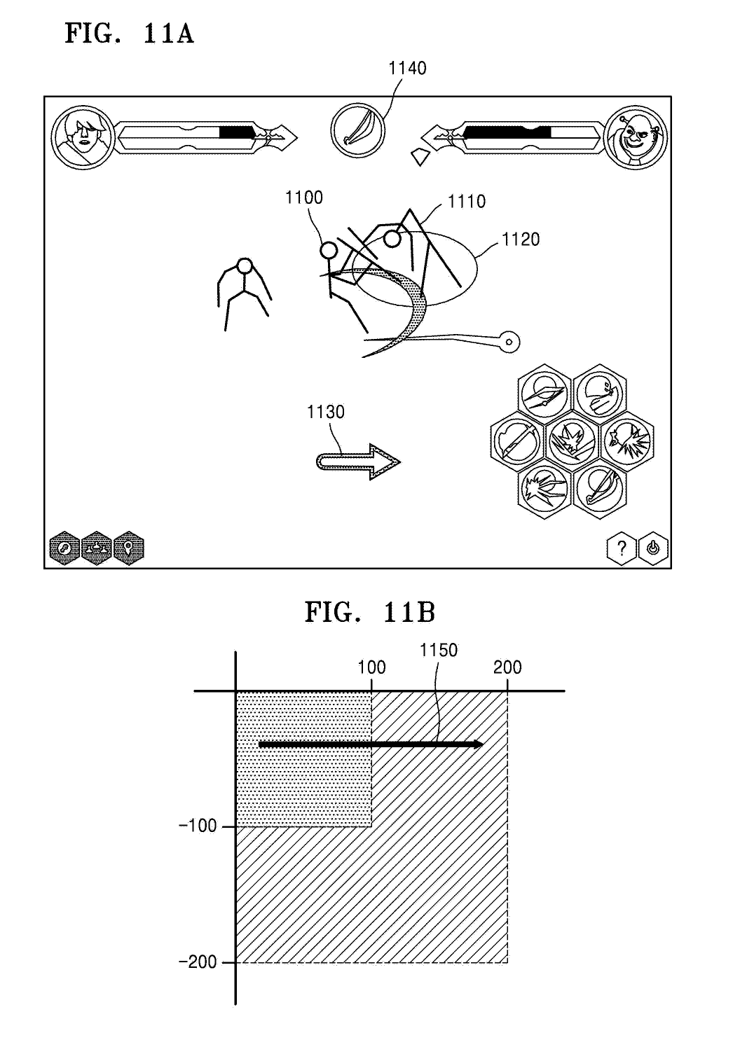

FIGS. 11A through 17B are diagrams for describing user gestures of various forms and functions thereof, according to an aspect of the presently disclosed embodiment.

Referring to FIGS. 11A and 11B, when a target character 1110 is targeted (1120) and a user inputs rightward drag 1150, the drag input is determined as a valid gesture and a function corresponding to the input gesture is performed. For example, if a user's character 1100 is an assassin, a function corresponding to ‘Amgitoocheok’ is performed. If the user's character 1100 is a warrior, a function corresponding to ‘Boonggyeok’ is performed. Next, a gesture shape 1130 and a function icon 1140 correspond thereto are displayed.

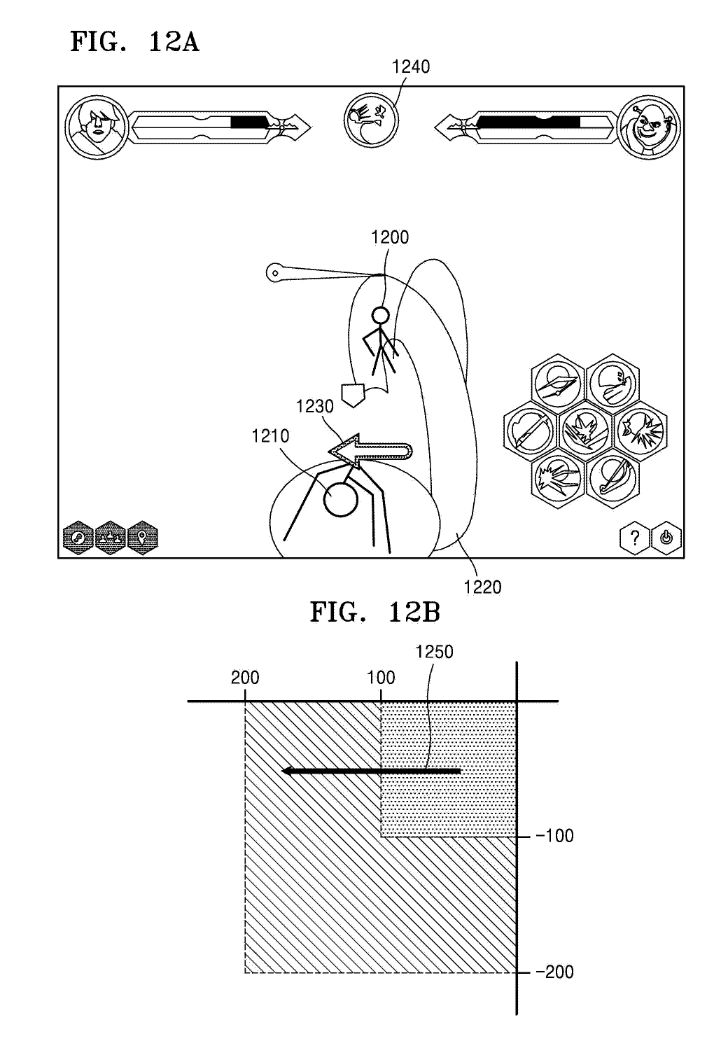

Referring to FIGS. 12A and 12B, when a target character 1210 is target (1220) and a user inputs a leftward drag 1250, the drag input is determined as a valid gesture and a function corresponding to the input gesture is performed. For example, if a user's character 1200 is an assassin, a function corresponding to ‘Hoepitoocheok’ is performed. If the user's character 1200 is a warrior, a function corresponding to ‘Pahoechook’ is performed. Next, a gesture shape 1230 and a function icon 1240 correspond thereto are displayed.

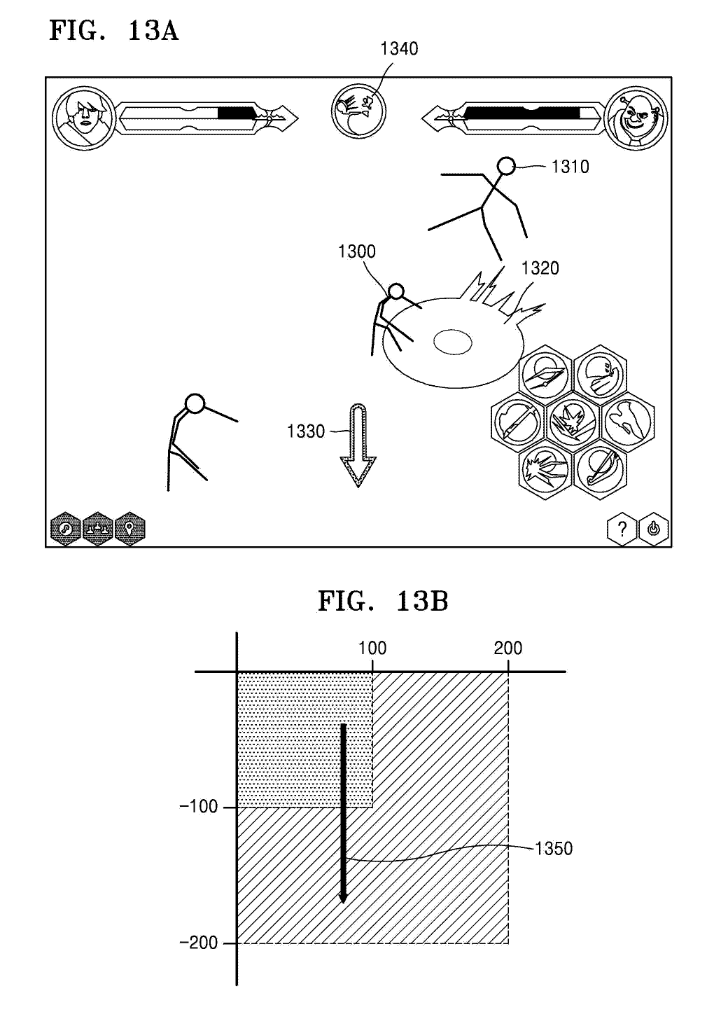

Referring to FIGS. 13A and 13B, when a target character 1310 is target (1320) and a user inputs a downward drag 1350, the drag input is determined as a valid gesture and a function corresponding to the input gesture is performed. For example, if a user's character 1300 is an assassin, a function corresponding to ‘Gyeokdo’ is performed. If the user's character 1300 is a warrior, a function corresponding to ‘Sajahoo’ is performed. Next, a gesture shape 1330 and a function icon 1340 correspond thereto are displayed.

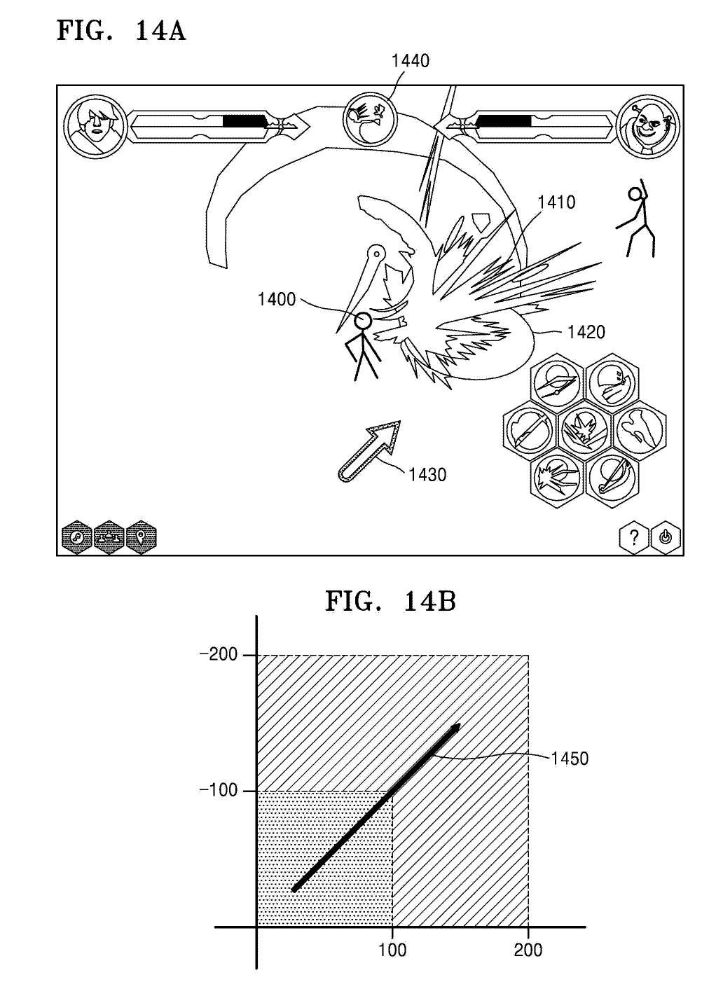

Referring to FIGS. 14A and 14B, when a target character 1410 is target (1420) and a user inputs a upper-rightward drag 1450, the drag input is determined as a valid gesture and a function corresponding to the input gesture is performed. For example, if a user's character 1400 is an assassin, a function corresponding to ‘Chungyeok’ is performed. If the user's character 1400 is a warrior, a function corresponding to ‘Seungryongcham’ is performed. Next, a gesture shape 1430 and a function icon 1440 correspond thereto are displayed.

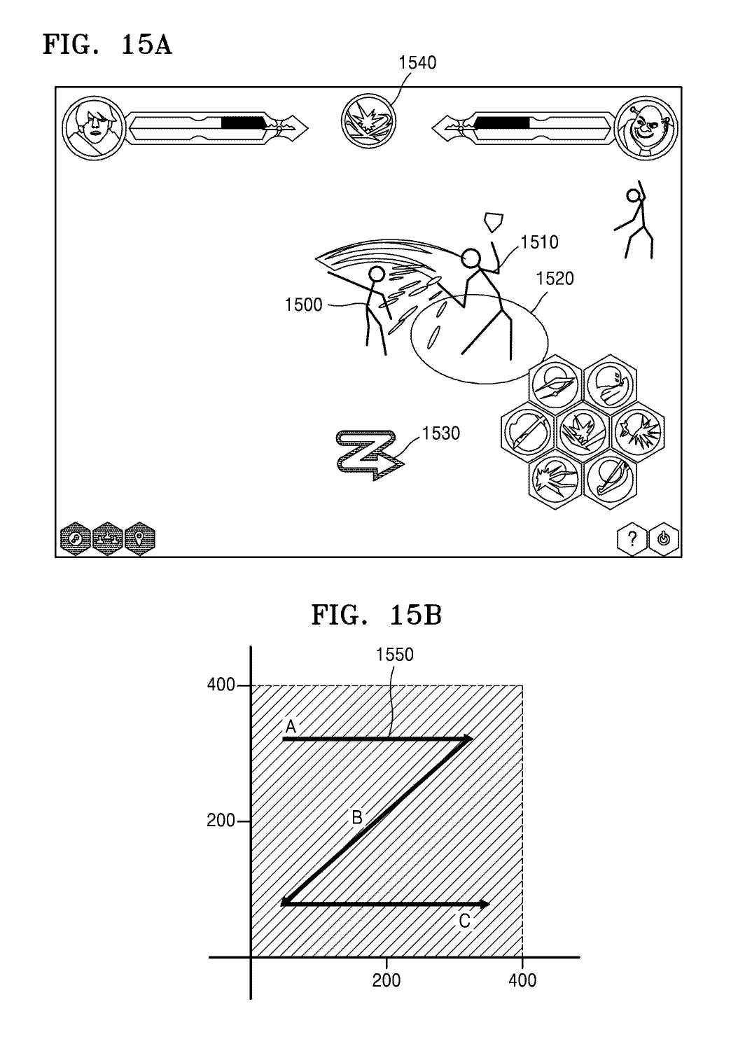

Referring to FIGS. 15A and 15B, when a target character 1510 is target (1520) and a user inputs a Z-shaped drag 1550, the drag input is determined as a valid gesture and a function corresponding to the input gesture is performed. For example, if a user's character 1500 is an assassin, a function corresponding to ‘Hyeolpoongcham’ is performed. If the user's character 1500 is a warrior, a function corresponding to ‘Gapkoopagoe’ is performed. Next, a gesture shape 1530 and a function icon 1540 correspond thereto are displayed.

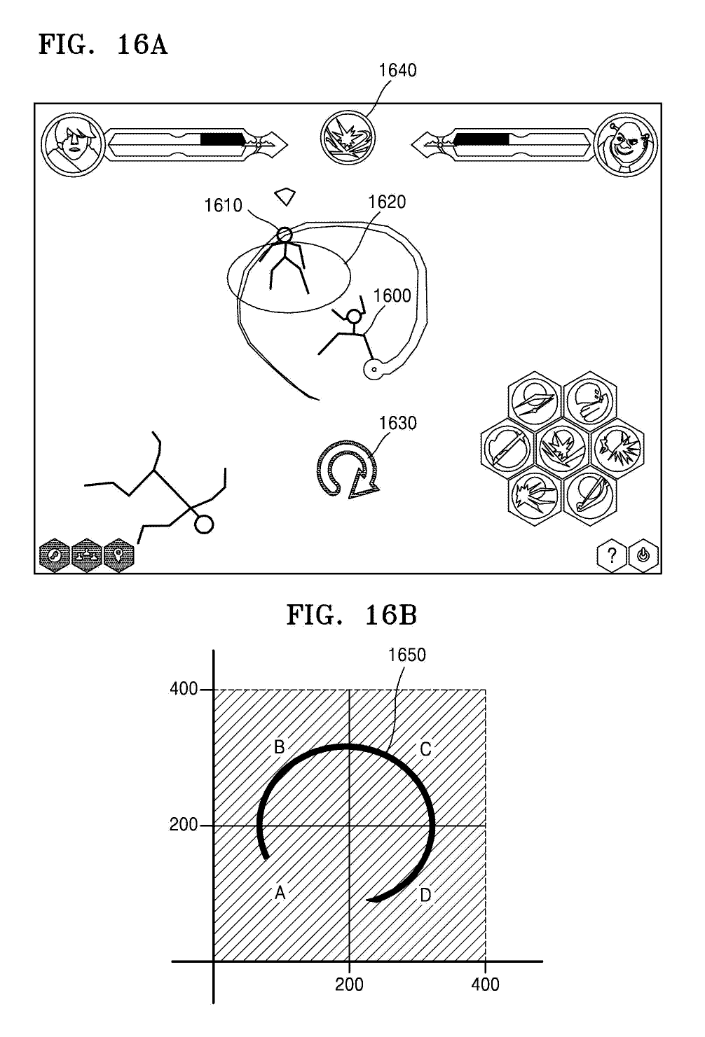

Referring to FIGS. 16A and 16B, when a target character 1610 is target (1620) and a user inputs a circular drag 1650, the drag input is determined as a valid gesture and a function corresponding to the input gesture is performed. For example, if a user's character 1600 is an assassin, a function corresponding to ‘Hyeolpoonggyeok’ is performed. If the user's character 1600 is a warrior, a function corresponding to ‘Jingijooyip’ is performed. Next, a gesture shape 1630 and a function icon 1640 correspond thereto are displayed.

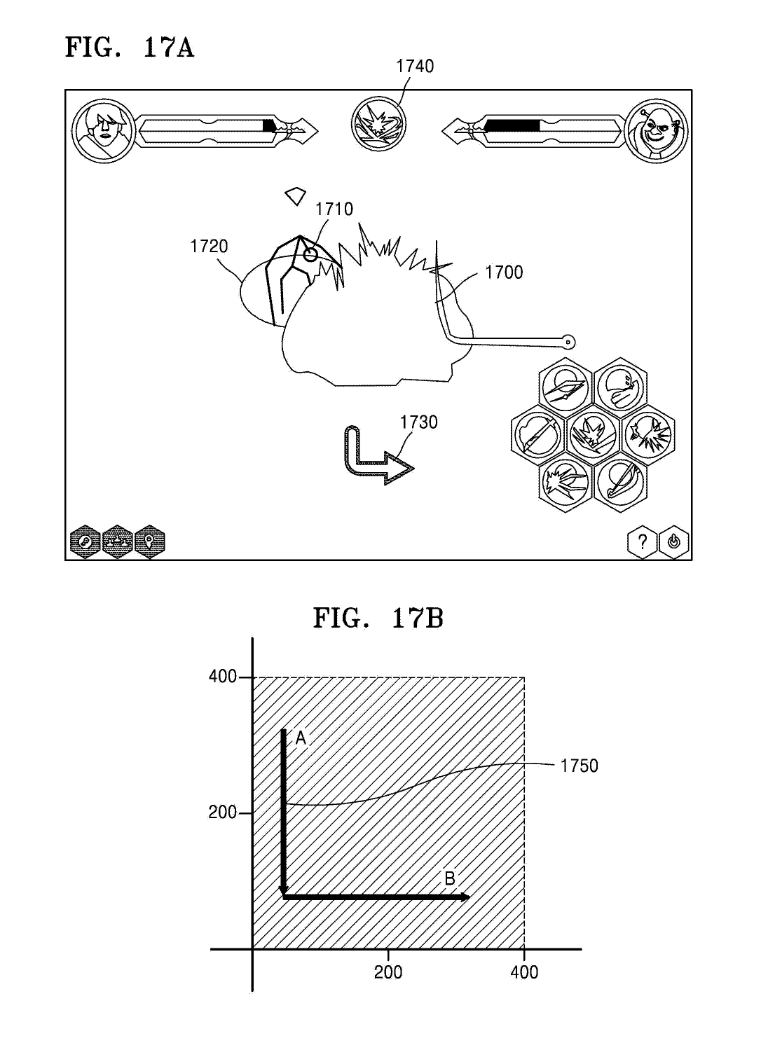

Referring to FIGS. 17A and 17B, when a target character 1710 is target (1720) and a user inputs an L-shaped drag 1750, the drag input is determined as a valid gesture and a function corresponding to the input gesture is performed. For example, if a user's character 1700 is an assassin, a function corresponding to ‘Poison Application’ is performed. If the user's character 1700 is a warrior, a function corresponding to ‘a body endowed with martial arts’ is performed. Next, a gesture shape 1730 and a function icon 1740 correspond thereto are displayed.

A method of processing user gestures in an online game performed via a mobile terminal capable of receiving a touch-drag input according to the above-stated aspects of the presently disclosed embodiment may be executed by a built-in application on the mobile terminal (which may include programs included in a built-in platform or an operating system) or may be executed by an application (that is, a program) installed on the terminal by a user via an application providing server, which includes an application store server or a web server related to a corresponding application or service. In this regard, the method of processing user gesture inputs according to the presently disclosed embodiment may be embodied as a built-in application (that is, a program) of a mobile terminal or an application installed by a user and may be recorded in a recording medium that can be read by a computer, including the mobile terminal.

The above-stated functions may be executed as such a program is recorded in a computer readable recording medium and is executed by a computer.

Accordingly, to implement methods of processing user gesture inputs according to aspects of the presently disclosed embodiment, the program may include codes coded in computer languages that can be read by a CPU of a computer, such as C, C++, JAVA, machine language, etc.

Such codes may include function codes related to functions defining the above-stated functions and may also include control codes related to implementation procedure required for a processor of a computer to implement the above-stated functions in a designated order.

Furthermore, such codes may further include memory reference related codes regarding locations (addresses) of a memory inside or outside the computer to refer additional information or media for a processor of a computer to perform the above-stated functions.

Furthermore, if it is necessary for a processor of a computer to communicate with another computer or a server at a remote location to perform the above-stated functions, the codes may further include communication-related codes instructing the processor of the computer how to communicate with the other computer or the server at the remote location or which of information or media to be transmitted/received via a communication module of the computer (e.g., a wire communication module and/or a wireless communication module).

Furthermore, a functional program for embodying the presently disclosed embodiment and codes and code segments related thereto may be easily inferred or modified by programmers in the art in consideration of system environment of a computer for reading a recording medium and executing the program.

Examples of computer-readable recording media having recorded thereon a program as described above includes a ROM, a RAM, a CD-ROM, a magnetic tape, a floppy disk, an optical media storage medium, etc., for example.

Furthermore, the computer readable recording medium can also be distributed over network coupled computer systems so that the computer readable code is stored and executed in a distributed fashion. In this case, at least one of a plurality of distributed computers may perform some of the above-stated functions and transmit a result of the performance to at least one other from among the plurality of distributed computers, and another computer that received the result may also perform some of the above-stated functions and provide a result of the performance to the other distributed computers.

Particularly, a computer readable recording medium having recorded thereon an application, which is a program for implementing methods of processing user gesture inputs according to aspects of the presently disclosed embodiment, may be a recording medium (e.g., a hard disk drive) included in an application provider server, which includes an application store server or a web server related to a corresponding application or service, or may be an application provider server itself.

Computers capable of reading a recording medium having recorded thereon an application, which is a program for implementing methods of processing user gesture inputs according to aspects of the presently disclosed embodiment, may include not only general PCs, such as a desktop PC and a laptop PC, but also mobile terminals, such as a smart phone, a tablet PC, a personal digital assistant (PDA), and a mobile communication terminal. However, the presently disclosed embodiment is not limited thereto, and it should be understood that any and all computing devices are applicable.

Furthermore, if a computer capable of reading a recording medium having recorded thereon an application, which is a program for implementing methods of processing user gesture inputs according to aspects of the presently disclosed embodiment, is a mobile terminal, such as a smart phone, a tablet PC, a PDA, and a mobile communication terminal, the application may be downloaded from an application provider server to a general PC and may be installed on the mobile terminal via a synchronization program.

A method of processing user gestures in an online game performed via a mobile terminal capable of receiving a touch-drag input according to an aspect of the presently disclosed embodiment may minimize the number of touches required for performing efficient and rapid operations, improve operating convenience, and provide pleasant view.

Here, although it is described above that all elements constituting an aspect of the presently disclosed embodiment are combined to one element and operate, the presently disclosed embodiment is not limited thereto. In other words, within the scope of the purpose of the presently disclosed embodiment, all of those elements may be selectively combined to one element and operate. Furthermore, each of the elements may be embodied as an independent hardware. Alternatively, the elements may be embodied as a computer program including a program module for performing functions of a part of or all of the elements on one or a plurality of hardware by selectively combining the elements partially or entirely with one another. Codes and code segments constituting the computer program may be easily inferred by one of ordinary skill in the art. The computer program may be stored on a computer readable recording medium and may be read and executed by a computer, thereby implementing aspects of the presently disclosed embodiment. Examples of the computer readable recording medium may include a magnetic recording medium and an optical recording medium.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this disclosed embodiment belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While this disclosed embodiment has been particularly shown and described with reference to preferred aspects thereof, it will be understood by those skilled in the art that various changes in form and details may be made therein without departing from the spirit and scope of the disclosed embodiment as defined by the appended claims. The preferred aspects should be considered in descriptive sense only and not for purposes of limitation. Therefore, the scope of the disclosed embodiment is defined not by the detailed description of the disclosed embodiment but by the appended claims, and all differences within the scope will be construed as being included in the presently disclosed embodiment.

What is claimed is:

1. A method of processing user gestures in an online game performed via a mobile terminal capable of receiving a touch-drag input, the method comprising:
determining whether a target character of the online game is targeted; and
performing a function corresponding to a gesture comprising at least one dragging direction in case where the target character is targeted or moving a user's character based on the touch-drag input in case where the target is not targeted.

2. The method of claim 1, further comprising:
if the target character is targeted, determining a valid range of the gesture input; and
if the gesture input is within the valid range, performing a function corresponding to the input gesture,
wherein the valid range is within the playing area of the user's character and the target character in the display area of the mobile terminal.

3. The method of claim 2, wherein, if the starting point of a drag constituting the gesture is located within the valid range, the gesture is determined as a gesture input within the valid range.

4. The method of claim 2, wherein, if the starting point of a drag constituting the gesture is located within the valid range, the gesture is determined as a gesture input within the valid range regardless of location of the end point of the gesture.

5. The method of claim 1, further comprising displaying a trail of the gesture from a location in the display area of the mobile terminal, the location corresponding to the starting point of a drag constituting the gesture.

6. The method of claim 1, wherein, if a function corresponding to the gesture is performed, an icon corresponding to the performed function and a shape indicating the gesture are displayed in the display area of the mobile terminal.

7. The method of claim 1, wherein the gesture comprises a unidirectional drag, and
the gesture is determined as a gesture input within a valid range if the gesture is located within at least one from between valid ranges respectively set with respect to the X-axis and the Y-axis.

8. The method of claim 1, wherein the gesture comprises drags in multiple directions,
if each of drags in first through N^{th} directions, where N is an integer equal to or greater than 2, is within at least one from between valid ranges respectively set with respect to the X-axis and the Y-axis, and,
if N−1 drags are valid, the gesture is determined as a gesture input within a valid range.

9. The method of claim 8, wherein it is determined whether the gesture consisting of drags in multiple directions including the drags in the first through N^{th} directions is a gesture input within a valid range, regardless of a direction corresponding to the initially input drag.

10. The method of claim 1, wherein, if the gesture is not one within a valid range, a function corresponding to a gesture similar to the gesture is performed.

11. The method of claim 1, where the function comprises at least one skill to be used by the user's character.

12. The method of claim 1, wherein a gesture guide, which comprises at least one function to be used by the user's character and gestures including the at least one dragging direction mapped to the function, is displayed in the display area of the mobile terminal.

13. The method of claim 1, wherein the online game is a RPG game including a MMORPG/MORPG, an aeon of strife (AOS) game, a real time strategy (RTS) game, a first/third person shooters (FPS/TPS) game, or a sport game.

14. A method of processing user gestures in an online game performed via a mobile terminal capable of receiving a touch-drag input, the method comprising:
determining whether a target character of the online game is targeted;
if the target character is targeted, determining a gesture input based on at least one from between dragging directions and the number of drags; and
if it is determined that a valid gesture is input, performing a function corresponding to the input gesture.

15. The method of claim 14, further comprising, if the target character is not targeted, moving a user's character based on the touch-drag input.

16. A mobile terminal for processing user gesture inputs in an online game, wherein the mobile terminal is capable of receiving touch-drag inputs and comprises:
a targeting determining unit, which determines whether a target character is targeted in the online game; and
a control unit, which performs a function corresponding to a gesture comprising at least one dragging direction
if the target character is targeted, determining valid range of the gesture input; and
performing a function corresponding to the input gesture in case where the gesture input is within the valid range or moving a user's character based on the touch-drag input in case where the target character is not targeted.

17. A non-transitory computer readable recording medium having recorded thereon a computer program for implementing a method of processing user gestures in an online game performed via a mobile terminal capable of receiving a touch-drag input, the computer readable recording medium comprising:
a first program code for determining whether a target character of the online game is targeted;
a second program code for performing a function corresponding to a gesture comprising at least one dragging direction in case where the target character is targeted; and
a third program code for moving a user's character based on the touch-drag input in case where the target is not targeted.
